(19) United States
(12) Patent Application Publication
(10) Pub. No.: US 2021/0060473 A1
(43) Pub. Date: Mar. 4, 2021

(54) METHOD FOR PROVIDING AN AIR STREAM

(71) Applicant: Carl Freudenberg KG, Weinheim (DE)

(72) Inventors: Thomas Caesar, Weinheim (DE); Thomas Schroth, Bobenheim-Roxheim (DE); Karsten Schulz, Neckarbischofsheim (DE); Sandra Sell-Poelloth, Maikammer (DE); Renate Tapper, Bensheim (DE); Patrick Weber, Weinheim (DE)

(21) Appl. No.: 17/005,331

(22) Filed: Aug. 28, 2020

(30) Foreign Application Priority Data
Aug. 29, 2019 (EP) 19 194 286.1

(51) Int. Cl. B01D 46/00; B01D 46/44

(52) U.S. Cl. CPC B01D 46/0086; F01D 21/003; B01D 46/442; B01D 46/0036

(57) ABSTRACT

A method for providing an air stream for a system, in particular a plant, includes the following steps: a. specifying an air requirement and a required degree of air purity of the system having the plant, and storing the values in a memory unit of a control module; b. cleaning the air stream in a filter module comprising filter elements; c. providing the air stream through the filter module to air inlets or air outlets of the system as a provided air stream; d. detecting a magnitude of the provided air stream and of an actual degree of air purity by a sensor system; e. comparing a magnitude of the provided air stream and of the actual degree of air purity to the stored values; and g. calculating a performance characteristic of the filter module. A volume of the provided air influences the performance characteristic.

### CROSS-REFERENCE TO PRIOR APPLICATION

Priority is claimed to European Patent Application No. EP 19 194 286.1, filed on Aug. 29, 2019, the entire disclosure of which is hereby incorporated by reference herein.

### FIELD

The invention relates to a method for providing an air stream.

### BACKGROUND

It is known from the prior art that a wide variety of systems in which processes run have a certain air requirement. For example, power generation plants may have a certain need for process supply air. This requirement usually comprises a certain amount of air and also a certain air quality. For this reason, filter modules having filter elements are used. The filter elements can be designed, for example, as surface filters, high-temperature filters or pocket filters. A filter module frequently comprises a plurality of filter stages, i.e. filter elements which are arranged in series.

### SUMMARY

In an embodiment, the present invention provides a method for providing an air stream for a system, in particular a plant, comprising the following steps: a. specifying an air requirement and a required degree of air purity of the system comprising the plant, and storing the values in a memory unit of a control module; b. cleaning the air stream in a filter module comprising filter elements; c. providing the air stream through the filter module to air inlets or air outlets of the system as a provided air stream; d. detecting a magnitude of the provided air stream and of an actual degree of air purity by a sensor system; e. comparing a magnitude of the provided air stream and of the actual degree of air purity to the stored values; and g. calculating a performance characteristic of the filter module, wherein a volume of the provided air influences the performance characteristic, wherein performance values of the filter module are accumulated over a specific period of time in order to determine the air stream cleaning carried out over the specific period of time, and wherein a time-related performance of the filter module is considered for the calculation only if the actual values meet at least the target values in relation to the specific period of time.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a first system in which an air stream is provided at an air inlet,

FIG. 2 shows a second system in which an air stream is provided at an air outlet, and

FIG. 3 shows the sequence of the method.

### DETAILED DESCRIPTION

In an embodiment, the present invention provides a method for providing an air stream. It should be ensured here that a necessary air requirement is provided and the performance of the air stream supply is quantified.

In an embodiment, the present invention provides a method for providing an air stream having the features described herein.

According to the invention, it has been found advantageous to calculate a performance characteristic of a filter module:

The method according to the invention serves to provide an air stream as process supply air or as process exhaust air for a system in which a process is carried out. The system is in particular a plant.

In a first step, an air requirement and a required degree of air purity of the system are specified. The air requirement can include the volume flow, the air quantity and the flow velocity. For example, the required degree of air purity may be specified as PM₁₀, PM_{2.5} or PM₁.

These values are stored in a memory unit of a control module. In other words: target values are established for air requirement and degree of air purity.

In a second step, an air stream is cleaned in a filter module. The air stream can be cleaned in the filter module by filtration of particles and/or adsorption of harmful gases.

The air stream can be fresh air, exhaust air or mixed air. The filter module, which is part of the system, has one or more filter elements with which contaminants such as particles or harmful gases can be removed from the air stream. This cleaned air stream is then provided by the filter module—in the case of process supply air—to air inlets or—in the case of process exhaust air—to air outlets of the system.

In a further step, the magnitude of the provided air stream and the provided actual degree of air purity is detected by a sensor system. For this purpose, sensors can be provided which detect, for example, the volume flow, the air quantity or the flow velocity in order to determine the provided air stream. Sensors can also be provided for determining the degree of air purity. Then, in a further step, the magnitude of the provided air stream and the actual degree of air purity is compared to the stored values, i.e. actual values are compared to target values.

In this application, a sensor is understood to mean the measuring unit for determining a measured variable. Thus, for example, 3 different measured variables can also be detected with 3 sensors in an air measuring unit and, for example, the contaminant concentration of 3 different contaminants can be derived. According to this understanding, the sensor not only comprises the unit in which a physical or chemical effect is detected (pickup) but also comprises the processing unit that converts this measured effect into a further processable electrical signal.

The magnitude of the provided air stream and of the provided actual degree of air purity can be detected either directly or indirectly. In the case of direct detection, the relevant magnitude is directly detected by measurement. With indirect detection, the relevant magnitude is calculated or derived based on a measured value. Indirect, consequential detection of the air stream can be effected using a sensor system, for example, by measuring the pressure difference at the filter and a fan speed and by taking into account the fan characteristic data of the air stream.

Finally, a performance characteristic of the filter module is calculated. For this purpose, performance values of the filter module are accumulated over a certain period of time, for example over one or more days, over a month or over a year. This serves to determine the air stream cleaning carried out over the specified period of time, wherein a time-related performance of the filter module is only taken into account for the calculation if the actual values at least meet the target values in relation to the specified time period under consideration. In other words: The performance for cleaning the air stream through the filter module is only taken into account when the requirements with regard to air requirement and degree of air purity are met.

In the method according to the invention, the volume of provided air influences the performance characteristic according to the last step.

In a particularly advantageous and therefore preferred further embodiment of the method according to the invention, the quantity of filtered contaminants in the filter module is determined using a sensor system, e.g. with determination of the mass, the volume or a particle count of filtered contaminants, in an additional step. To determine the mass of the quantity of filtered contaminants, a scale integrated into the filter module or else an external scale can be used.

According to a first further embodiment, the concentration of contaminants in the supply air and in the exhaust air of the filter module is detected by the sensor system. The loading of the filter elements with contaminants can thus be determined by calculation, as described, for example, in DE 1 035 3897 B4. In an alternative or supplementary further embodiment, the sensor system detects the pressure loss through the filter elements of the filter module. The loading of the filter elements with contaminants can thus also be determined by calculation, as described, for example, in EP 1 467 071A1. The quantity of filtered contaminants determined in this way can, in particular, influence the performance characteristic of the filter module.

In an advantageous and therefore particularly preferred further embodiment of the method according to the invention, in a further, subsequent step, a cost figure is assigned to the performance characteristic and a price for the air stream cleaning performed in the filter module is thus determined. The cost figure can be provided, for example displayed, to the operator and/or user of the system.

In a possible further embodiment of the method, the control module controls the filter elements of the filter module and thus their cleaning performance based on the comparison of the actual values to the target values, and controls the air stream.

The system can be designed as a building, for example as a hospital, with a certain requirement for clean, fresh air. Alternatively, the system can be designed as a plant, in particular as a power generation plant, as a turbo machine (e.g. as a gas motor or compressor) or as a production plant. The production plant can be used, for example, for the production of foods or beverages in which surface technology is employed, in particular as a painting plant, or for the production of pharmaceutical products.

The described invention and the described advantageous further embodiments of the invention constitute advantageous further embodiments of the invention also in combination with one another, insofar as this is technically reasonable.

The invention will now be explained in more detail using the accompanying figures. Corresponding elements and components are provided with the same reference symbols in the figures. For the sake of better clarity of the figures, a presentation that is true to scale has been dispensed with.

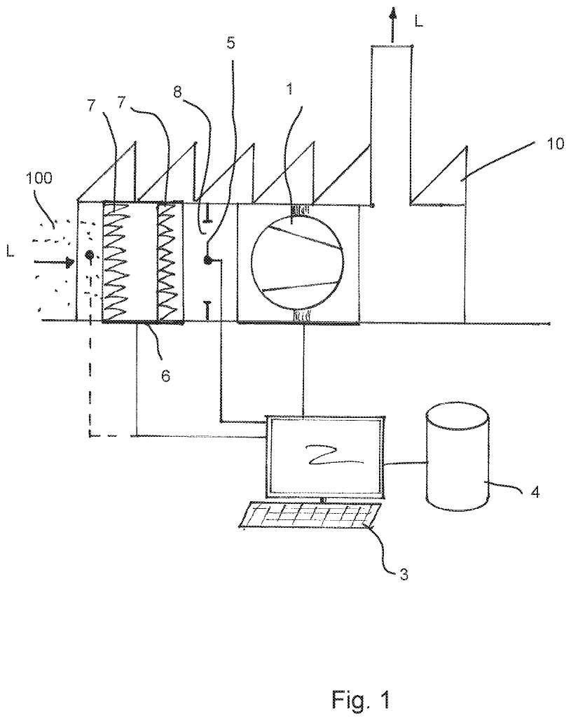

FIG. 1 shows a system 10 which is designed as a power generation plant 1. The system 10 is supplied with an air stream L as process supply air. The air stream L is contaminated and contains contaminants 100. These contaminants 100 can be removed by a filter module 6 having a plurality of filter elements 7 so that a cleaned air stream L is made available to the power generation plant 1. This air stream L is provided at an air inlet 8. A specific air requirement and a specific degree of air purity are required for safe and reliable operation of the power generation plant 1. Target values relating to the air requirement and the required degree of air purity can be stored in a memory unit 4. The magnitude of the air stream L provided and the actual degree of air purity can be detected by means of sensor system 5, which comprises at least one sensor. A control module 3 can compare the actual values to the target values and can calculate and provide a performance characteristic of the filter module 6. In addition, the control module 3 could also control the filter module 6 and the air stream. In the exemplary embodiment shown in FIG. 1, the sensor system 5 comprises sensors that are arranged in the region of the air inlet 8. The sensors serve to detect the provided air stream L and the actual degree of air purity. As indicated by dashed lines, a further sensor can be provided which is arranged upstream of the filter module 6. This sensor can be used, for example, to detect the contaminant concentration in the supply air.

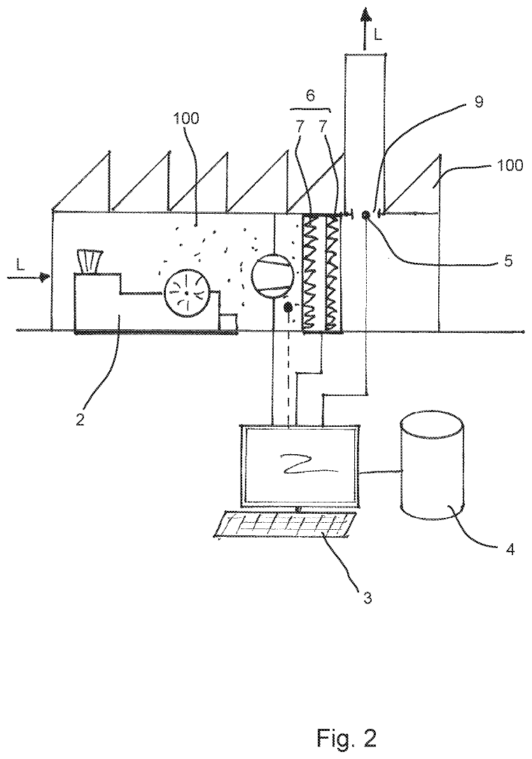

FIG. 2 shows a similar system 100. Contaminated process exhaust air is generated by a production plant 2. The process exhaust air with air contamination 100 can be passed through a filter module 6 having a plurality of filter elements 7 and thereby cleaned by suction, which is not shown in detail. There are requirements determined by the production plant 2 with regard to an air requirement of process exhaust air, i.e. a specific air exchange. There are normally legal requirements for air purification with regard to the degree of air purity of the process exhaust air. Compliance with these legal requirements can be ensured by the system 10 shown, and the control module 3 can be used to calculate and provide a performance characteristic of the filter module 6. The suction module and the filter module 6 can also optionally be controlled by the control module 3.

The system could also be designed as a production plant in which there is a certain need for clean air, for example process supply air in pharmaceutical production. The system could also be designed as a building in which there is a certain need for clean air, for example as a hospital with operating rooms.

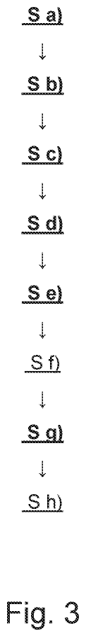

FIG. 3 indicates the sequence of the method, wherein the respective method steps are designated with S. Mandatory steps are shown in bold, optional steps are shown in regular font.
1. Method for providing an air stream for a system 10, in particular a plant 1, 2, comprising the following steps:
S a) Specifying an air requirement and a required degree of air purity of the system 10, in particular of the plant, and storing the values in a memory unit 4 of a control module 3.
S b) Cleaning an air stream L in a filter module 6 comprising filter elements 7.
S c) Providing the air stream L through the filter module 6 to air inlets 8 or air outlets 9 of the system, in particular the plant.
S d) Detecting the magnitude of the provided air stream L and of the actual degree of air purity via sensor system 5.
S e) Comparing the magnitude of the supplied air stream L and of the actual degree of air purity to the stored values.
S f) optional: Determining the filtered contaminant quantity 100 in the filter module 6 using sensor system 5.
S g) Calculating a performance characteristic of the filter module 6.
S h) optional: Assigning a cost figure to the performance characteristic.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Power plant
2 Production plant
3 Control module
4 Memory unit
5 Sensor system
6 Filter module
7 Filter element
8 Air inlet
9 Air outlet
10 System (for example, plant)
100 Air contamination (contaminants)
L Air stream

What is claimed is:

1. A method for providing an air stream for a system, in particular a plant, comprising the following steps:
a. specifying an air requirement and a required degree of air purity of the system comprising the plant, and storing the values in a memory unit of a control module;
b. cleaning the air stream in a filter module comprising filter elements;
c. providing the air stream through the filter module to air inlets or air outlets of the system as a provided air stream;
d. detecting a magnitude of the provided air stream and of an actual degree of air purity by a sensor system;
e. comparing a magnitude of the provided air stream and of the actual degree of air purity to the stored values; and
g. calculating a performance characteristic of the filter module,
wherein a volume of the provided air influences the performance characteristic,
wherein performance values of the filter module are accumulated over a specific period of time in order to determine the air stream cleaning carried out over the specific period of time, and
wherein a time-related performance of the filter module is considered for the calculation only if the actual values meet at least the target values in relation to the specific period of time.

2. The method according to claim 1, further comprising an additional step of:
f. determining an amount of contaminant filtered in the filter module using the sensor system as a filtered contaminant.

3. The method according to claim 2, wherein the sensor system is configured to detect a contaminant concentration in supply air and in exhaust air of the filter module.

4. The method according to claim 2, wherein the sensor system is configured to detect a pressure loss via the filter elements of the filter module.

5. The method according to claim 2, wherein the filtered contaminant quantity influences the performance characteristic.

6. The method according to claim 1, further comprising an additional step of:
h. assigning a cost figure to the performance characteristic.

7. The method according to claim 1, wherein in step b. particles are filtered and/or harmful gases are adsorbed in the filter module.

8. The method according to claim 1, wherein in step e. the control module controls the filter module and the air stream.

9. The method according to claim 1, wherein the system comprises a building or the plant, in particular as a power generation plant, as a turbo machine or as a production plant.

10. The method according to claim 9, wherein the system comprises the plant, and wherein the plant comprises a power generation plant.

11. The method according to claim 10, wherein the power generation plant comprises a turbo machine or a production plant.
